(19) United States
(12) Patent Application Publication
(10) Pub. No.: US 2023/0157508 A1
(43) Pub. Date: May 25, 2023

(54) EXTRACTION INTERFACE FOR CONNECTING A FIRST FLOW CHANNEL TO A SECOND FLOW CHANNEL IN AN AIRTIGHT MANNER, BASE STATION WITH AN EXTRACTION INTERFACE AND SYSTEM CONSISTING OF A VACUUM CLEANING APPLIANCE AND A BASE STATION

(71) Applicant: Vorwerk & Co. Interholding GmbH, Wuppertal (DE)

(72) Inventors: Bjoern SOIKA, Bochum (DE); Helmut SCHOENHOFF, Remscheid (DE)

(73) Assignee: Vorwerk & Co. Interholding GmbH, Wuppertal (DE)

(21) Appl. No.: 17/982,565

(22) Filed: Nov. 8, 2022

(30) Foreign Application Priority Data
Nov. 23, 2021 (EP) 21209897.4

(51) Int. Cl. A47L 11/40; A47L 11/24

(52) U.S. Cl. CPC A47L 11/4025; A47L 11/24; A47L 2201/024

(57) ABSTRACT

An extraction interface for connecting a first flow channel to a second flow channel in an airtight manner has a main body with an extraction opening. The extraction opening has an opening plane and a sealing element that surrounds the extraction opening in the circumferential direction. In order to improve a sealing effect of the sealing element, the sealing element is an elastic bellows, which when viewed in a cross section oriented orthogonal to the opening plane has in a relaxed state of the sealing element an E-shape with at least one bending point, two legs that meet in the bending point and two leg end regions adjoining the legs. The leg end regions point radially outward in a direction facing away from the extraction opening and are connected to two locally separated connecting points of the main body.

### CROSS REFERENCE TO RELATED APPLICATIONS

Applicant claims priority under 35 U.S.C. § 119 of European Application No. 21209897.4 filed Nov. 23, 2021, the disclosure of which is incorporated by reference.

### BACKGROUND OF THE INVENTION

### 1. Field of the Invention

The invention initially pertains to an extraction interface for connecting a first flow channel to a second flow channel in an airtight manner, wherein the extraction interface has a main body with an extraction opening, and wherein the extraction opening has an opening plane and a sealing element that surrounds the extraction opening in the circumferential direction.

In addition, the invention pertains to a base station for evacuating a dust chamber of a vacuum cleaning appliance, wherein the base station has a base housing with a fan arranged in the base housing, a first flow channel and an extraction interface for connecting the fan to a second flow channel of the vacuum cleaning appliance in a flow-conducting manner.

The invention furthermore pertains to a system consisting of a vacuum cleaning appliance and a base station.

### 2. Description of the Related Art

Extraction interfaces of the aforementioned type are used in a large number of technical devices that have a flow channel, which should be connected to a flow channel of another device. Such extraction interfaces have an extraction opening with an opening plane, wherein air drawn in by a fan flows through said extraction opening. A vacuum is generated within the flow channel in this case and causes an air flow in the direction of the fan.

Extraction interfaces known from the prior art have the disadvantage that the vacuum being generated in the flow channel causes the sealing element surrounding the extraction opening to collapse and to be drawn into the flow channel, i.e. in the direction of the fan, such that the sealing element is removed from a contact region to be sealed and no longer can optimally fulfill its sealing function.

Extraction interfaces of this type can be used particularly, but not exclusively, in a base station that has a suction fan for evacuating a dust chamber of a vacuum cleaning appliance, e.g. a vacuum cleaner. In this case, the extraction interface has a sealing element that forms a seal between the base station and the vacuum cleaning appliance connected to the base station.

For example, the vacuum cleaning appliance may be a self-propelled vacuum cleaning appliance that can autonomously travel to the base station and dock with the extraction interface of the base station. Such base stations and vacuum cleaning appliances serve for carrying out an autonomous floor treatment such as floor cleaning and/or floor care, particularly in households or office environments.

For example, publication EP 3 505 036 B1 discloses a base station and a vacuum cleaning appliance that autonomously docks with the base station. The base station has a platform with charging contacts for charging an accumulator of the vacuum cleaning appliance, as well as an extraction interface for connecting a flow channel of the vacuum cleaning appliance to a flow channel of the base station.

### SUMMARY OF THE INVENTION

Based on the above-described prior art, the invention aims to enhance an extraction interface such that the sealing effect between the sealing element of the extraction interface and the flow channel is improved, particularly in such a way that that an optimal sealing effect of the sealing element is preserved when a vacuum acts upon the extraction interface.

In order to attain this objective, it is proposed that the sealing element is realized in the form of an elastic bellows, which viewed in a cross section oriented orthogonal to the opening plane has in a relaxed state of the sealing element an E-shape with at least one bending point, two legs that meet in the bending point and two leg end regions adjoining the legs, wherein the leg end regions point radially outward in a direction facing away from the extraction opening and are connected to two locally separated connecting points of the main body.

According to the invention, the sealing element now has a bent, buckled or folded shape, which referred to a cross-section orthogonal to the opening plane forms an E-shape, on a circumferential surface delimiting the extraction opening. The term E-shape refers to cross-sectional shapes, i.e. profiles, of the sealing element, which have a bending point that faces radially inward and forms a constriction of the sealing element such that the opening diameter of the extraction opening is maximal in the plane of the bending point. Two legs extend to the end faces of the extraction interface starting from this bending point. Furthermore, a leg end region oriented, for example, parallel to the opening plane adjoins each of the legs. Such a leg end region particularly may extend parallel to a surface of the main body of the extraction interface and be fastened thereon in an airtight manner. Furthermore, a leg end region may also be inclined relative to the opening plane, e.g. by an angle of up to 45 degrees. In this context, an E-shape also includes the shape of a mathematical summation sign Σ that likewise has a bending point, two legs that meet in the bending point and two leg end regions adjoining the legs. Due to such an E-shape or summation sign shape, the sealing element has a cross-sectional shape that forms a bellows at least on the side delimiting the extraction opening, wherein the folds of said bellows can expand or contract in dependence on the value of a vacuum within the extraction opening. It is also possible that the sealing element not only has a single bending point, i.e. two folds, but rather multiple bending points. The bending point of the sealing element allows an expansion of the sealing element in the direction of the flow channel connected to the extraction interface, e.g. a vacuum cleaning appliance connected to the extraction interface, in that the vacuum being generated in the extraction opening deforms the bending point in such a way that its bending radius is enlarged and the height of the sealing element increases in the direction of a surface normal of the opening plane. In this way, the sealing element is advantageously pressed against the second flow channel connected to the extraction interface, e.g. a vacuum cleaning appliance connected thereto. Height tolerances particularly can be compensated. Since the constriction of the bending point also points away from the center of the extraction opening due to the concave design, the sealing element does not collapse into the extraction opening or into the connected flow channel during the erection of the sealing element.

The sealing element may have a closed annular design with respect to its cross-section, i.e. its profile. However, the profile may alternatively also be open on one side facing away from the extraction opening. In this context, the term leg end region therefore does not necessarily have to be interpreted in such a way that the leg end region is a free leg end region. In fact, the leg end region may also transition into another region of the sealing element directly, i.e. without interruption. For example, both leg end regions of the sealing element may also be directly connected to one another or connected to one another with interposition of another segment of the sealing element. In the context of the invention, it is essential that at least a segment of the sealing element has an E-shape or Σ-shape referred to the cross section of the sealing element. It is of particular importance that the sealing element is made of an elastic material such that it can act as an elastic bellows. This refers particularly and at least to the E-shape (or summation sign shape) comprising the bending point, the legs meeting in the bending point and the leg end regions adjoining the legs.

The sealing element particularly is manufactured in one piece and can in a purely functional sense be divided into essentially three segments, namely firstly a first leg end region that is fastened on the main body of the extraction interface, secondly an inner circumferential surface that delimits the extraction opening, essentially is oriented orthogonal to the opening plane, represents the actual circumferential bellows structure of the sealing element and comprises the bending point with the two legs meeting in the bending point, and thirdly a second leg end region that is fastened on a segment of the main body of the extraction interface facing away from the first leg end region. In a transition region to the adjoining leg of the inner circumferential wall, the second leg end region serves as a sealing surface relative to a second flow channel or relative to an appliance to be connected to the extraction interface, e.g. a vacuum cleaning appliance.

It is proposed that the sealing element is designed for expanding in the region of the bending point when a vacuum is generated in the opening plane such that the bending radius of the bending point is enlarged. Due to the elastic design, the bending point of the bellows structure of the inner circumferential surface of the sealing element allows an expansion, i.e. an elongation, of the sealing element in a direction extending orthogonal to the opening plane of the extraction opening of the extraction interface. A sealing surface, which preferably is formed in a transition region between the upper leg end region and the adjoining leg, therefore is respectively pressed against a contacting flow channel or an appliance housing of an external appliance with a greater force. The elasticity of the sealing element, particularly the bending point, and the length of the legs meeting in the bending point are chosen such that the expected vacuum within the extraction interface suffices for achieving the expanding deformation of the bending point. This depends on the specific utilization of the extraction interface, particularly on the suction power of a fan that generates a vacuum on the extraction interface.

The outer sides of the legs meeting in the bending point delimit the extraction opening and preferably extend at an angle of 50 degrees to 65 degrees relative to the opening plane of the extraction opening in a relaxed state of the sealing element. The surfaces of the inner circumferential wall of the sealing element, i.e. of the legs meeting in the bending point, therefore are inclined relative to the opening plane of the extraction opening by an angle of 50 degrees to 65 degrees. As a result, the bending point and the adjoining legs of the sealing element are drawn inward, i.e. in the direction of a center of the extraction opening, when a vacuum acts upon the extraction opening. The sealing element therefore becomes erect and presses against the connected flow channel with a greater force. The pressing force between the sealing element and the sealing partner therefore increases. The vacuum being generated in the extraction interface furthermore ensures that the entire sealing region of the sealing element tends to be drawn inward in the direction of a center of the opening plane and the fact that the expected vacuum cannot lead to a reduction of the opening cross-section of the opening plane therefore has to be taken into account in the dimensioning of the angle of the bending point and the lengths of the adjoining legs, as well as in the material selection.

In this context, it would furthermore be conceivable that the leg end regions have a greater length than the respectively adjoining leg. The shorter legs of the sealing element have a greater mechanical stability than the longer leg end regions and do not have to be additionally fixed. On the other hand, the longer leg end regions are respectively fixed on a connecting point of the main body of the extraction interface, wherein the two connecting points of the leg end regions are locally separated from one another. Since the leg end regions are fixed and the legs are realized shorter than the leg end regions, the bending point has such a stability that the sealing element does not bulge inward, i.e. in the direction of the center of the extraction opening, on its inner circumferential surface delimiting the extraction opening, but rather continues to form a concave surface of the sealing element that does not reduce the opening cross-section of the extraction opening.

It is furthermore proposed that, referred to the cross section oriented orthogonal to the opening plane, a first leg end region of the sealing element is connected to a connecting point of the main body in a laminar manner, and that a second leg end region of the sealing element is fixed on a connecting point of the main body so as to be movable relative to the main body, wherein the second leg end region particularly is pivotable relative to the connecting point. According to this embodiment, the second leg end region, which forms the actual sealing surface relative to the connected second flow channel, is connected to the main body in a more movable manner than the first leg end region, which is connected to a contact surface of the main body in a laminar manner and therefore does not provide any freedom of movement in this segment of the sealing element. The second leg end region particularly is arranged on the main body in a pivotable manner, namely such that a deformation of the sealing element in the region of the second leg end region, the second leg connected thereto and the bending point can be realized as a result of a pivoting motion of this second leg end region. When the extraction opening of the extraction interface is acted upon, the connecting point between the second leg end region and the main body of the extraction interface acts as a pivot point or pivot axis that allows a displacement of the second leg end region toward the second flow channel and therefore an expansion of the bending point. In this way, the sealing surface of the second leg end region is additionally pressed against the second flow channel such that the sealing effect of the sealing element of the extraction interface is enhanced.

The first leg end region may be bonded, welded or snap-locked to the connecting point of the main body and/or the connecting point of the main body may have plug elements that are inserted into corresponding plug receptacles of the first leg end region. The sealing element may in principle either be connected to the main body of the extraction interface permanently, namely such that the sealing element cannot be removed from the main body without being destroyed, or alternatively in such a way that the sealing element can optionally also be removed and exchanged, particularly by means of a plug-type connection. According to a particularly preferred embodiment, the main body of the extraction interface has plug elements that can be inserted through corresponding plug receptacles of the sealing element, namely its first leg end region. In this case, the leg end region pointing toward the main body serves as circumferential fixing ring that fixes the sealing element on the main body.

It is furthermore proposed that the sealing element is made of a thermoplastic elastomer, wherein the sealing element particularly has a material hardness of 30 Shore A to 60 Shore A. The proposed sealing element therefore is realized in the form of a soft plastic component that allows a deformation of the shape of the sealing element and, in particular, the above-described expansion of the bending point. A sealing element with a material hardness of 30 Shore A to 60 Shore A proved particularly successful in practical applications.

In addition to the above-described extraction interface, the invention furthermore proposes a base station for evacuating a dust chamber of a vacuum cleaning appliance, wherein the base station has a base housing with a fan arranged in the base housing, a first flow channel and an extraction interface for connecting the fan to a second flow channel of the vacuum cleaning appliance in a flow-conducting manner, and wherein the extraction interface is designed in accordance with one of the above-described embodiments.

According to this design, the above-described extraction interface forms part of a base station that serves for being connected to an external vacuum cleaning appliance. The base station has a fan that serves for evacuating a dust chamber of the vacuum cleaning appliance. To this end, a first flow channel of the base station and a second flow channel of the vacuum cleaning appliance are connected to one another by means of the extraction interface. The extraction interface may be an integral component of the base housing of the base station such that the base housing of the base station at the same time also forms the main body of the extraction interface. Alternatively, the main body of the extraction interface may also be realized in the form of a separate element that is connected to the base housing of the base station, e.g. by means of bonding or welding. It is essential that the first flow channel of the base station is routed to the extraction interface, namely in such a way that it leads to the extraction opening of the extraction interface and can be connected to a second flow channel of a vacuum cleaning appliance connected to the base station.

In addition to the function of evacuating a dust chamber, the base station may also be designed for carrying out other service activities. For example, the base station may have a charging device for charging an accumulator of a vacuum cleaning appliance. The base station may be a floor-supported station, i.e. stand on a floor surface, or also be realized in the form of a wall-mounted base station. For example, the vacuum cleaning appliances that can be connected to the base station may be self-propelled vacuum cleaning robots or alternatively also vacuum cleaning appliances that are manually operated by a user, e.g. handheld vacuum cleaners that cannot autonomously travel to the base station.

It is particularly proposed that the base station has a base plate for at least partially accommodating the vacuum cleaning appliance, wherein the extraction interface of the base station is with respect to an orientation of the base station during a vacuuming mode arranged on an upwardly directed surface of the base plate such that a surface normal of an opening plane of the extraction interface essentially is oriented vertically. The thusly designed base station particularly may serve for being connected to a self-propelled vacuum cleaning appliance that can at least partially travel onto the base plate, namely in such a way that a flow channel leading to a dust chamber of the vacuum cleaning appliance can be connected to the extraction interface of the base station. According to a specific embodiment, the dust chamber may in the docking position of the vacuum cleaning appliance with the base station lie directly above the extraction interface such that dust and dirt accumulated in the dust chamber can be transported in the direction of the base station under the influence of gravity and with the assistance of the vacuum generated at the extraction interface by the fan of the base station. The base station particularly may have a mechanical guiding device in order to guide the vacuum cleaning appliance during the docking process with the base station in such a way that the flow channel of the vacuum cleaning appliance can be optimally connected to the extraction interface. This advantageously applies to self-propelled vacuum cleaning appliances, as well as to vacuum cleaning appliances that are manually connected to the base station by a user.

In addition to the above-described base station, the invention furthermore proposes a system consisting of a vacuum cleaning appliance and such a base station, wherein the base station has the first flow channel and the extraction interface, wherein the vacuum cleaning appliance has the second flow channel, wherein the extraction interface is designed for connecting the first flow channel to the second flow channel in an airtight manner when the vacuum cleaning appliance is connected to the base station, and wherein the sealing element of the extraction interface is designed in such a way that the sealing element is during the operation of the fan of the base station expanded in the direction of the vacuum cleaning appliance by enlarging the bending radius of the bending point of the sealing element due to a vacuum acting in the region of the extraction interface. The system therefore is designed in such a way that the first flow channel of the base station and the second flow channel of the vacuum cleaning appliance meet at the extraction interface such that the fan can extract vacuumed material out of the dust chamber of the vacuum cleaning appliance. To this end, the fan generates the vacuum in the corresponding flow channels and ultimately the dust chamber of the vacuum cleaning appliance. In order to connect the vacuum cleaning appliance or its second flow channel to the extraction interface of the base station in an airtight manner, the extraction interface of the base station is according to the invention designed in such a way that the sealing element is during the operation of the fan expanded in the direction of the vacuum cleaning appliance by enlarging the bending radius of the bending point due to the vacuum. In this way, the sealing element is additionally pressed in the direction of the vacuum cleaning appliance and enhances the sealing effect at this location. The bellows-like design of the sealing element and the proposed fixing of the sealing element on the main body of the extraction interface also prevents the sealing element from collapsing when a vacuum acts upon the extraction opening, wherein such a collapse would reduce the opening cross section of the extraction opening of the base station and therefore could lead to an accumulation of dust and dirt. In the idle state, i.e. in the non-expanded state, the sealing element or its bending point has a maximal constriction in the region of the extraction opening such that an expanding movement of the sealing element can result in the region of the bending point when a vacuum acts upon the opening cross section of the extraction opening.

The above-described additional designs and functions of the extraction interface and the base station also apply accordingly to the inventive system such that a repetition of the corresponding portions of the description is deemed unnecessary at this point.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the Drawings,

FIG. 1 shows an inventive system consisting of a vacuum cleaning appliance and a base station,

FIG. 2 shows an oblique top view of the base station with an extraction interface for the vacuum cleaning appliance,

FIG. 3 shows a sealing element of the extraction interface,

FIG. 4 shows a perspective cross section through the sealing element,

FIG. 5 shows a segment of the base station comprising the extraction interface, as well as a segment of the vacuum cleaning appliance connected thereto, and

FIG. 6 shows a bottom view of the extraction interface of the base station with the sealing element connected thereto.

### DETAILED DESCRIPTION OF PREFERRED EMBODIMENTS

The figures show a potential embodiment of an inventive system, as well as an inventive base station 20 and a correspondingly designed vacuum cleaning appliance 21. However, it goes without saying that the base station 20 and the vacuum cleaning appliance 21 can also be designed differently, as long as the base station 20 and the vacuum cleaning appliance 21 are designed in such a corresponding manner that the vacuum cleaning appliance 21 can optimally dock with an extraction interface 1 of the base station 20.

In this example, the vacuum cleaning appliance 21 is realized in the form of a self-propelled cleaning robot, namely a vacuuming robot. In the context of the invention, however, it is alternatively also possible that the vacuum cleaning appliance 21 is a vacuum cleaning appliance 21 that is manually operated by a user and cannot autonomously travel to the base station 20. In such an embodiment, the user places the vacuum cleaning appliance 21, for example, into a receptacle of the base station 20 in order to connect the vacuum cleaning appliance 21 to the extraction interface 1.

The vacuum cleaning appliance 21 comprises a cleaning element 17, which in this example is realized in the form of a cleaning roller that rotates about a horizontal axis, as well as two motor-driven wheels 16. Furthermore, the vacuum cleaning appliance 21 may be optionally equipped with support rollers that, however, are not described in greater detail.

The vacuum cleaning appliance 21 is also equipped with a not-shown accumulator that delivers the energy required for driving the wheels 16 and the rotating cleaning element 17 and optionally is also available for other electronic and electric components of the vacuum cleaning appliance 21. In this example, the vacuum cleaning appliance 21 furthermore has a control unit, which receives data from an environment detection device, in order to navigate and self-locate within an environment. For example, the environment detection device may comprise a laser distance sensor that measures distances to obstacles in the environment of the vacuum cleaning appliance 21. An environment map, which serves for the navigation and self-locating of the vacuum cleaning appliance 21, can then be generated by the control unit based on these measured distances. Apart from the distance sensor, the vacuum cleaning appliance 21 may also be equipped with additional sensors such as an odometric sensor that measures a movement of the vacuum cleaning appliance 21, one or more contact sensors, ultrasonic sensors or other sensors.

The base station 20 has a base housing 22 and a base plate 25, which extends on a floor surface in a plate-like manner starting from the base housing 22. The base plate 25 provides an upper side 26, onto which the vacuum cleaning appliance 21 can travel in order to assume a docked end position with the base station 20. The base plate 25 preferably is inclined in order to make it easier for the vacuum cleaning appliance 21 to travel onto the base plate 25. The base housing 22 of the base station 20 is furthermore equipped with a base dust chamber 27, a fan 24 and a first flow channel 2 that is routed to the extraction interface 1 starting from the base dust chamber 27.

The vacuum cleaning appliance 21 is also equipped with a dust chamber 23 for accommodating vacuumed material, i.e. dust and dirt removed from a floor surface, and a second flow channel 3, which is routed from the dust chamber 23 to an interface that is not illustrated in greater detail and can dock with the extraction interface 1 of the base station 20. According to FIG. 1, the first flow channel 2 of the base station 20 and the second flow channel 3 of the vacuum cleaning appliance 21 therefore can be connected to one another by means of the extraction interface 1 in order to empty the dust chamber 23 of the vacuum cleaning appliance 21 into the base dust chamber 27 of the base station 20 with the aid of the fan 24 of the base station 20.

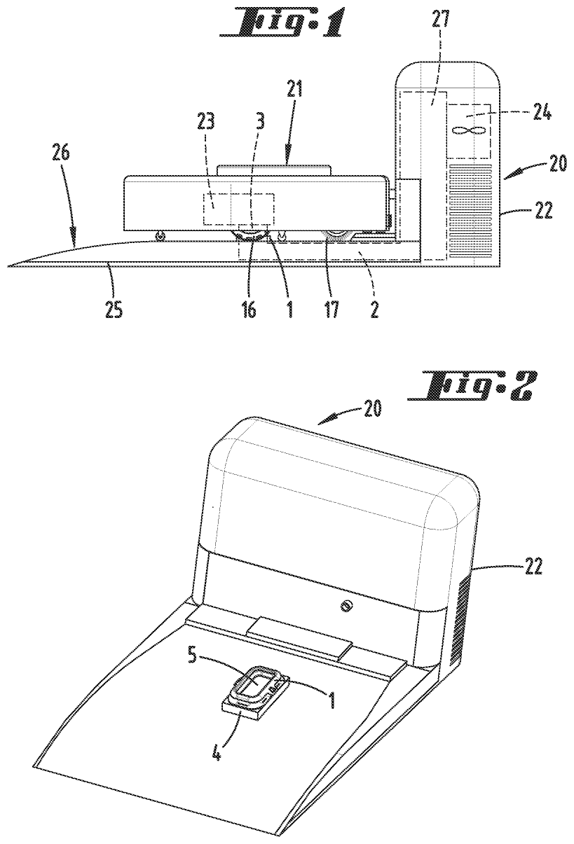

FIG. 2 shows the base station 20 in the form of a perspective top view. This figure shows the upper side 26 of the base plate 25 with the extraction interface 1. The extraction interface 1 is equipped with a sealing element 7 that delimits an extraction opening 5 of the extraction interface 1. The base housing 22 and/or the base plate 25 of the base station 20 may provide additional interfaces for being coupled to the vacuum cleaning appliance 21, but these interfaces are not illustrated in greater detail. For example, the base housing 22 or the base plate 25 preferably has electrical contacts that can be connected to corresponding electrical contacts of the vacuum cleaning appliance 21. Furthermore, guide tracks may be formed on the base plate 25 in order to steer the vacuum cleaning appliance 21 into a certain docking position with the base station 20.

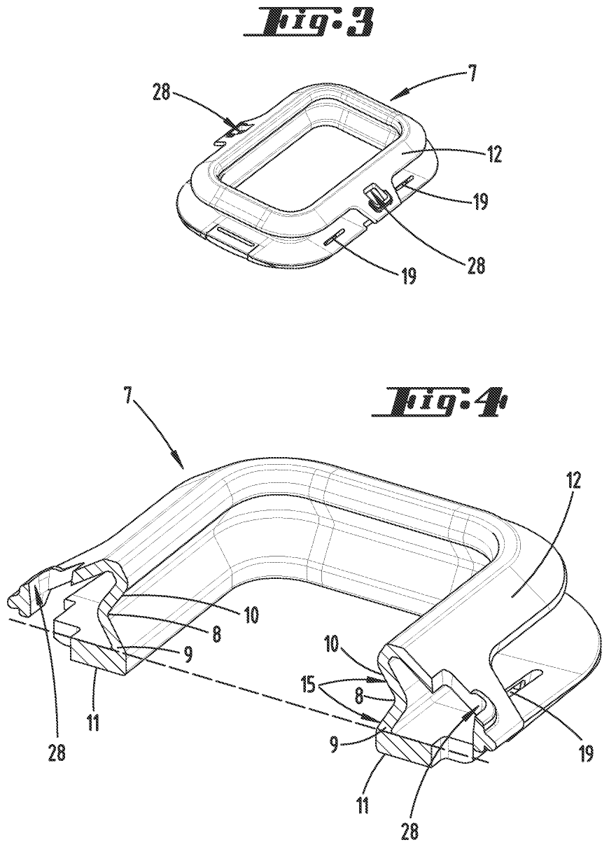

FIG. 3 shows a perspective view of the sealing element 7. FIG. 4 furthermore shows a cross-section through the sealing element 7 orthogonal to an opening plane 6 of the extraction opening 5 and transverse to the circumferential direction of the sealing element 7 that extends annularly around the extraction opening 5. With respect to the cross section, the sealing element 7 essentially has an E-shape or summation sign shape (Σ). This shape is characterized by two legs 9, 10 that are angled relative to one another and meet in a common bending point 8 and by two leg end regions 11, 12, of which a first leg end region 11 adjoins the first leg 9 and a second leg end region 12 adjoins the second leg 10. The sealing element 7 is made of a thermoplastic material that preferably has a Shore A hardness between 30 and 60. The first leg end region 11 and the second leg end region 12 serve for connecting the sealing element 7 to a respective connecting point 13, 14 of a main body 4 of the extraction interface 1, wherein said main body 4 may form, for example, an integral housing part of a device comprising the extraction interface 1, in this case the base station 20.

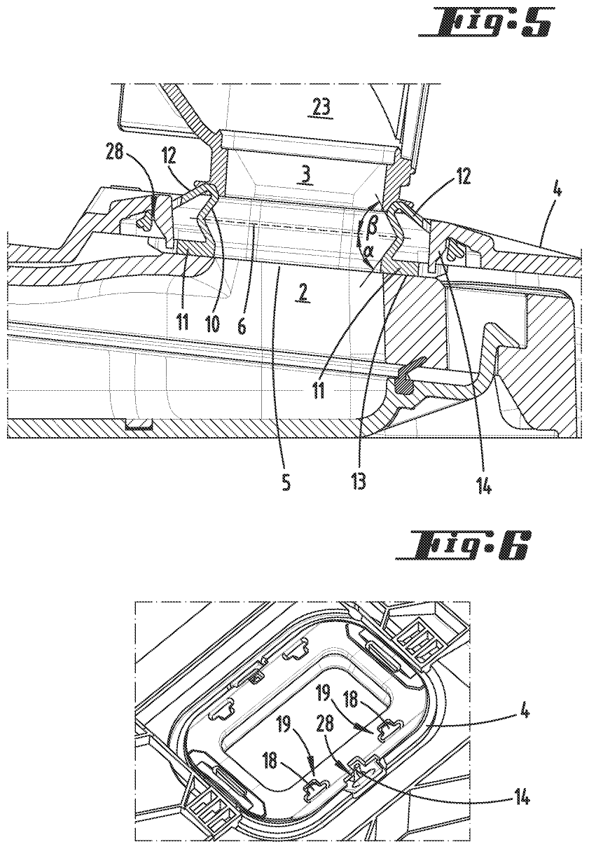

FIGS. 5 and 6 show an installation situation of the sealing element 7 in the base plate 25 of the base station 20. FIG. 5 respectively shows a cross-section through the extraction interface 1, as well as corresponding interconnected segments of the base station 20 and the vacuum cleaning appliance 21 (FIG. 5), and a bottom view of the sealing element 7 connected to the base plate 25.

FIGS. 3 to 6 show that the sealing element 7 has plug receptacles 19 on the first leg end region 11, as well as openings 28 on the second leg end region 12. The plug receptacles 19 of the first leg end region 11 serve for being connected to corresponding plug elements 18 of the main body 4 of the extraction interface 1, wherein said plug elements are inserted through the plug receptacles 19 of the sealing element 7 as illustrated in FIG. 6 in order to fasten the lower leg end region 11 on a corresponding connecting point 13 of the main body 4 in a laminar manner. The circumferential leg end region 11 therefore serves as a fixing ring that fixes the sealing element 7 on the main body 4 of the extraction interface 1 in an altogether airtight manner. The leg end region 11 may have a plurality of such plug receptacles 19 in the circumferential direction.

The sealing element 7 has the openings 28, which serve for producing a connection with the connecting points 14 of the main body 4 of the extraction interface 1, on the opposite side of the E-shape or summation sign shape. In the present exemplary embodiment, the second leg end region 12 respectively has only one opening 28 on opposite circumferential sides of the sealing element 7, but it would also be possible to provide additional openings 28 that can be connected to corresponding connecting points 14 of the main body 4 of the extraction interface 1. FIG. 6 and FIG. 5, in particular, show that a hook-shaped connecting point 14 of the main body 4 of the extraction interface 1 extends through the opening 28 of the second leg end region 12 of the sealing element 7. A freedom of movement for the second leg end region 12 is preserved due to the hook-shaped design of the connecting point 14 on the appliance side and the size of the opening 28 such that this second leg end region can move relative to the extraction interface 1. A clearance also remains in the opening 28 when the hook-shaped connecting point 14 is inserted into the opening 28 and therefore allows the movement of the second leg end region 12 relative to the connecting point 14. In this case, a contact point between the connecting point 14 and the leg end region 12 serves as a pivot axis or pivot point, about which the leg end region 12 can rotate.

The invention works by initially connecting the sealing element 7 to corresponding connecting points 13, 14 of the extraction interface 1 of the base station 20 with the aid of the plug receptacles 19 and the openings 28 during the installation of the base station 20. According to FIG. 6, the connecting points 14 are to this end inserted into the respectively associated openings 28 and the plug elements 18 are inserted into the corresponding plug receptacles 19.

In an installed yet still relaxed state, the sealing element 7 has the shape illustrated in FIGS. 3 and 5, in which the first leg 9 (lower leg) and the second leg 10 (upper leg) respectively include an angle α, β with the opening plane 6 of the extraction opening 5 of the extraction interface 1, wherein said angle amounts to approximately 58 degrees in this example. In the relaxed starting position shown, the angles α, β preferably are dimensioned in such a way that they lie between 50 degrees and 65 degrees. The inclined position of the legs 9, 10 relative to the opening plane 6 forms a constriction in the region of the bending point 8 of the sealing element 7 such that the outer side 15 of the sealing element 7, which is realized in the form of a hollow body, is constricted in the region of the bending point 8. The folded shape of the outer side 15 results in the inventive function of the extraction interface 1, which is described in greater detail below.

The second flow channel 3 of the vacuum cleaning appliance 21 initially is connected to the extraction interface 1 of the base station 20 in order to empty the dust chamber 23 of the vacuum cleaning appliance 21 at the base station 20. In the case of the self-propelled vacuum cleaning appliance 21 shown, the vacuum cleaning appliance autonomously travels to and couples with the base station 20 in such a way that the second flow channel 3 of the vacuum cleaning appliance 21 is arranged on the extraction interface 1 of the base station 20 in a positionally corresponding manner. An end region of the second flow channel 3 or a corresponding interface of the vacuum cleaning appliance 21 then mechanically abuts on the sealing element 7 of the extraction interface 1 of the base station 20. This is illustrated, in particular, in FIG. 5. The fan 24 of the base station 20 is started as soon as a control of the base station 20 detects the contact of the vacuum cleaning appliance 21 with the extraction interface 1. It is alternatively also possible that the fan 24 is already started prior to detecting a contact with the extraction interface 1. For example, the fan 24 may already be activated when a wheel 16 of the vacuum cleaning appliance 21 contacts the base plate 25. A vacuum is generated in the first flow channel 2 of the base station 20 and therefore also within the extraction opening 5 of the extraction interface 1 due to the operation of the fan 24, wherein said vacuum draws the outer side 15 of the sealing element 7 inward in the direction of a center of the opening plane 6. This leads to an expansion of the outer side 15 at the bending point 8 such that the angles α, β are enlarged. This is achieved in that the connection between the second leg end region 12 and the connecting point 14 allows a rotation of the leg end region 12 about an axis that is essentially oriented parallel to the longitudinal extent of the bending point 8 (that extends in the circumferential direction of the sealing element 7). The bending radius of the bending point 8 can thereby be enlarged, which all in all leads to an expansion of the sealing element 7, particularly its outer side 15, in the direction of the vacuum cleaning appliance 21 connected to the extraction interface 1 such that the sealing element 7 is pressed against the second flow channel 3 of the vacuum cleaning appliance 21 or another corresponding part of the vacuum cleaning appliance 21 representing the interface of the vacuum cleaning appliance 21 with a greater force. The sealing element 7 furthermore is shaped in such a way that an applied vacuum does not lead to a reduction of the smallest opening cross section of the extraction interface 1 (referred to a state without vacuum). In fact, the sealing element 7 is shaped in such a way that the sealing element 7 primarily expands in the direction of the vacuum cleaning appliance 21. With consideration of the intrinsic flexibility of the soft-elastic material of the sealing element 7, for example, a slight reduction of the opening cross section actually occurs in the opening plane 6 when a vacuum is applied whereas a minimal expansion of the opening cross section takes place in the region of a contact between the sealing element 7 and the flow channel 3. No significant change of the opening cross section occurs in a transition region between the leg end regions 11 and the connecting points 13, 14 of the main body 4 when a vacuum is applied within the extraction interface 1. In the context of the invention, it is important that the sealing element 7 as a whole is under the influence of a vacuum not reduced beyond the smallest opening cross section (referred to a state in which it is not acted upon by a vacuum). To this end, the leg end regions 11, 12, which are longer than the legs 9, 10, are fastened on the connecting points 13, 14 of the main body 4 of the extraction interface 1. The legs 9, 10 of the sealing element 7, which are shorter than the leg end regions 11, 12, are mechanically stable due to their shorter length and not fixed separately. The legs 9, 10 are so stable that an applied vacuum does not draw them inward, i.e. into the extraction opening 5, beyond a completely expanded position of the outer side 15, in which the angles α, β relative to the opening plane 6 of the extraction opening 5 amount to 90 degrees. In fact, it is advantageous that the angles α, β are even in the expanded end position of the bending point 8 smaller than 90 degrees, particularly smaller than 85 degrees. This ensures that the outer side 15 does not “fold over,” i.e. that the other side 15 does not assume a convex shape.

The angles α, β of the legs 9, 10 relative to the opening plane 6 of the extraction opening 5 amount to approximately 50 degrees to 65 degrees in the relaxed state of the sealing element 7, i.e. when no vacuum acts upon the sealing element. In this way, the vacuum draws the legs 9, 10 inward such that the sealing element 7 tends to become erect and the height of the seal orthogonal to the opening plane 6 is increased. Consequently, the pressing force against the vacuum cleaning appliance 21 connected to the extraction interface 1 is increased. The vacuum applied in the extraction interface 1 exerts a pulling force upon the outer side 15 of the sealing element 7. Since the leg end region 12 of the sealing element 7 facing the vacuum cleaning appliance 21 is movably connected to the connecting point 14 of the extraction interface 1, a resulting force about the thusly formed pivot axis, which leads to an erection of the sealing element 7, can be generated. In this way, the described increase of the pressing force of the sealing element 7 against the corresponding surface of the vacuum cleaning appliance 21 is achieved. This allows an optimal lossless transfer of the vacuumed material from the dust chamber 23 of the vacuum cleaning appliance 21 into the base dust chamber 27 of the base station 20.

Although only a few embodiments of the present invention have been shown and described, it is to be understood that many changes and modifications may be made thereunto without departing from the spirit and scope of the invention.

### LIST OF REFERENCE SYMBOLS

1 Extraction interface
2 First flow channel
3 Second flow channel
4 Main body
5 Extraction opening
6 Opening plane
7 Sealing element
8 Bending point
9 Leg
10 Leg
11 Leg end region
12 Leg end region
13 Connecting point
14 Connecting point
15 Outer side
16 Wheel
17 Cleaning element
18 Plug element
19 Plug receptacle
20 Base station
21 Vacuum cleaning appliance
22 Base housing
23 Dust chamber
24 Fan
25 Base plate
26 Upper side
27 Base dust chamber
28 Opening
α Angle
β Angle

What is claimed is:

1. An extraction interface for connecting a first flow channel to a second flow channel in an airtight manner, comprising:
a main body with an extraction opening, wherein the extraction opening has an opening plane, and
a sealing element that surrounds the extraction opening in a circumferential direction,
wherein the sealing element is in the form of an elastic bellows, which, when viewed in a cross section oriented orthogonal to the opening plane, has in a relaxed state of the sealing element an E-shape with at least one bending point, two legs that meet in the bending point and two leg end regions adjoining the legs, and
wherein the leg end regions point radially outward in a direction facing away from the extraction opening and are connected to two locally separated connecting points of the main body.

2. The extraction interface according to claim 1, wherein the sealing element is configured for expanding in a region of the bending point when a vacuum is generated in the opening plane such that a bending radius of the bending point is enlarged.

3. The extraction interface according to claim 1, wherein outer sides of the legs meeting in the bending point delimit the extraction opening and extend at an angle (α, β) of 50 degrees to 65 degrees relative to the opening plane of the extraction opening in a relaxed state of the sealing element.

4. The extraction interface according to claim 1, wherein the leg end regions have a greater length than the respectively adjoining leg.

5. The extraction interface according to claim 1, wherein the leg end regions of the sealing element comprise a first leg end region and a second leg end region, wherein the first leg end region is with respect to the cross section oriented orthogonal to the opening plane connected to a connecting point of the main body in a laminar manner, wherein the second leg end region is fixed on a connecting point of the main body so as to be movable relative to the main body, and wherein the second leg end region is pivotable relative to the connecting point.

6. The extraction interface according to claim 5, wherein the first leg end region is bonded, welded or snap-locked to the connecting point of the main body.

7. The extraction interface according to claim 5, wherein the connecting point of the main body has plug elements that are inserted into corresponding plug receptacles of the first leg end region.

8. The extraction interface according to claim 1, wherein the sealing element is made of a thermoplastic elastomer and has a material hardness of 30 Shore A to 60 Shore A.

9. A base station for evacuating a dust chamber of a vacuum cleaning appliance, comprising:
a base housing with a fan arranged in the base housing,
a first flow channel, and
the extraction interface according to claim 1, wherein the extraction interface connects the fan to a second flow channel of the vacuum cleaning appliance in a flow-conducting manner.

10. The base station according to claim 9, wherein the base station has a base plate configured for at least partially accommodating the vacuum cleaning appliance, and wherein with respect to an orientation of the base station during a vacuuming mode, the extraction interface of the base station is arranged on an upwardly directed surface of the base plate such that a surface normal of an opening plane of the extraction interface is oriented essentially vertically.

11. A system consisting of a vacuum cleaning appliance and a base station in accordance with claim 9, wherein the base station has the first flow channel and the extraction interface, wherein the vacuum cleaning appliance has the second flow channel, wherein the extraction interface is designed for connecting the first flow channel to the second flow channel in an airtight manner when the vacuum cleaning appliance is connected to the base station, and wherein the sealing element of the extraction interface is configured such that the sealing element is, during the operation of the fan of the base station, expanded in a direction of the vacuum cleaning appliance by enlarging a bending radius of the bending point of the sealing element due to a vacuum acting in a region of the extraction interface.
